(19) United States
(12) Patent Application Publication
(10) Pub. No.: US 2006/0261243 A1
(43) Pub. Date: Nov. 23, 2006

(54) Optical reproducing apparatus capable of using laser diode of two wavelengths

(76) Inventors: Soo-han Park, Yongin-si (KR); Bong-gi Kim, Suwon-si (KR); Chun-seong Park, Suwon-si (KR); Jung-woo Hong, Suwon-si (KR); Jong-uk Kim, Yongin-si (KR)

Correspondence Address: STEIN, MCEWEN & BUI, LLP, 1400 EYE STREET, NW, SUITE 300, WASHINGTON, DC, 20005, US

(21) Appl. No.: 10/569,088

(22) PCT Filed: Dec. 22, 2003
(86) PCT No.: PCT/KR03/02799

§ 371 Date: Feb. 21, 2006

(30) Foreign Application Priority Data
Nov. 3, 2003 (KR) 10-2003-0077350

(51) Int. Cl. G02B 7/04

(52) U.S. Cl. 250/201.5

(57) ABSTRACT

An optical reproducing apparatus having a photo detector using a laser diode of two wavelengths. A 16-split photo diode for detecting laser beams respectively for a DVD and a CD enables an optical pick-up compatible with a wide variety of optical discs to be achieved by applying the laser diode of two wavelengths. Focusing error signals and tracking error signals are detected by using different methods according to a type of optical disc, improving production yield and decreasing manufacturing costs of a multi-disc reproduction apparatus.

### TECHNICAL FIELD

The present invention relates to an optical reproducing apparatus. More particularly, the present invention relates to an optical reproducing apparatus that detects and converts a laser beam scanned from a two-wavelength laser diode into an electric signal, and generates a focusing error signal and a tracking error signal by applying a preset method according to a type of an optical disc.

### BACKGROUND ART

Generally, optical reproducing apparatus reproduces data recorded on an optical disc as a signal recognizable by a user. The optical discs are divided into a compact disc (CD) and a digital video disc (DVD), and the DVD comprises a DVD±R, a DVD±RW, a DVD-ROM and a DVD-RAM. To this end, recently, the optical reproducing apparatus is provided with a function of reproducing data, compatibly with the various types of optical discs.

The optical reproducing apparatus comprises an optical pickup for scanning a laser beam on a surface of the optical disc and reading the data. For this, the optical pickup comprises a variety of optical elements such as a laser diode for scanning the laser beam, a diffraction grating, a beam splitter, a plurality of lenses for forming an optical path and a photo-sensor for detecting an optical signal. The optical signal detected by the photo-sensor is used for a focusing servo and a tracking servo.

The optical pickup suggests different methods for detecting the optical signal according to types of the optical discs. However, since the conventional optical pickup performs the focusing servo and the tracking servo according to a method appropriate for recording formats of the DVD±R, a DVD±RW and a DVD-ROM, when the optical reproducing apparatus is able to compatibly use the CD and the DVD, the optical disc may fail to correctly detect from the DVD-RAM the optical signal for the focusing servo and the tracking servo.

Also, when the optical reproducing apparatus provides compatibility between the CD and the DVD, the optical pickup scans laser beams having different wavelengths according whether the optical disc is the CD or the DVD. To this end, the optical pickup separately comprises a laser diode dedicated for the CD and a laser diode dedicated for the DVD, and therefore, a CD optical system and a DVD optical system are separately provided. Accordingly, the number of the optical elements increases in the conventional optical pickup, thereby complicating the structure of the optical system.

Therefore, when the optical reproducing apparatus provides compatibility between the CD and the DVD, productivity of the conventional optical pickup deteriorates due to the complicated assembling. Also, process-yield deteriorates, a manufacturing cost rises due to increase of the optical elements, and the optical signal for the focusing servo and the tracking servo may not be correctly detected from the DVD-RAM.

### SUMMARY OF THE INVENTION

Accordingly, an aspect of the present invention is to provide an optical reproducing apparatus capable of implementing a simplified, minimized and inexpensive optical pickup apparatus, which properly detects a laser beam scanned from a laser diode of two wavelengths according to use.

In order to achieve the above-described aspects of the present invention, there is provided an optical reproducing apparatus where the laser diode of two wavelengths can be applied, using a 16-split optical detector.

Here, the laser diode of two wavelengths scans a laser beam for a digital video disc (DVD) and a laser beam for a compact disc (CD). The optical detector generates a focusing error signal and a tracking error signal from the laser beam reflected from the DVD or the CD. For this, the optical detector comprises a 12-split detector for detecting the laser beam reflected from the DVD and a 4-split detector for detecting the laser beam reflected from the CD.

If the optical reproducing apparatus mounts therein a DVD-RAM, the optical detector generates the focusing error signal based on differential astigmatism detection method and the tracking error signal based on differential push pull. When one of a DVD±R, a DVD±RW and a DVD-ROM is mounted in the optical reproducing apparatus, the optical detector generates the focusing error signal based on the astigmatism detection method and the tracking error signal based on a differential phase detection method. When a CD is mounted in the optical reproducing apparatus, the optical detector generates the focusing error signal based on the astigmatism detection method and the tracking error signal based on a differential phase detection method. According to this, an optical system of the optical pickup can be simplified even with the laser diode of two wavelengths.

### BRIEF DESCRIPTION OF THE DRAWINGS

The above aspect and other features of the present invention will become more apparent by describing in detail exemplary embodiments thereof with reference to the attached drawing figures, wherein;

FIG. 1 schematically shows an optical reproducing apparatus according to an embodiment of the present invention;

FIG. 2 schematically shows a holder having a two-wavelength laser diode (LD) and a diffraction grating of FIG. 1;

FIG. 3 illustrates arrangement of respective sensors constructing an optical detector of FIG. 1;

FIG. 4 is a block diagram schematically showing a signal generation part connected to the optical detector;

FIGS. 5A to 5C are drawings for explaining processes for generating a first FE signal and a first TE signal from a DVD-RAM;

FIGS. 6A to 6C are drawings for explaining processes for generating a 2FE signal and a 2TE signal from a DVD±R, a DVD±RW and a DVD-ROM; and

FIGS. 7A to 7C are drawings for explaining processes for generating a 3FE signal and a 3TE signal from a CD.

### BEST MODE FOR CARRYING OUT THE INVENTION

Hereinafter, an embodiment of the present invention will be described in detail with reference to the accompanying drawing figures.

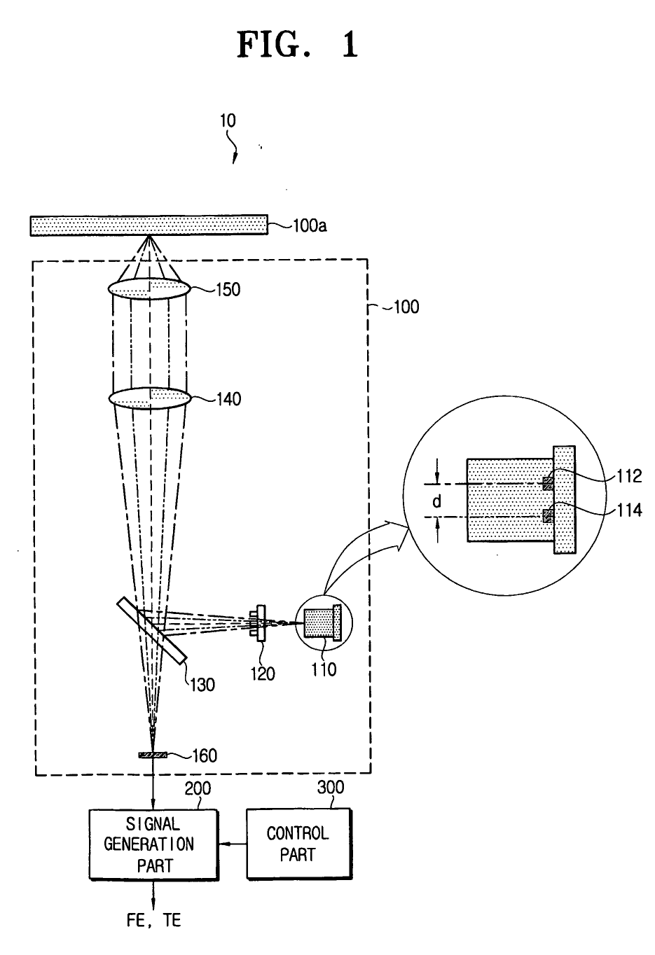

FIG. 1 is a drawing schematically showing an optical reproducing apparatus according to an embodiment of the present invention.

Referring to FIG. 1, an optical reproducing apparatus 10 according to an embodiment of the present invention comprises an optical pickup 100, a signal generation part 200 and a control part 300. The optical reproducing apparatus 10 reproduces data recorded on an optical disc 100a. FIG. 1 only illustrates a block in relation to the present invention, and other general function blocks will be omitted.

For the optical reproducing apparatus 10, a compact disc player (CDP), a digital video disc player (DVDP) and a digital video disc recorder (DVDR) can be used. The optical disc 100a, which is a recording medium for recording data, may comprise a DVD-type such as a DVD-R, DVD+R, DVD-RW, DVD+RW, DVD-ROM and DVD-RAM and a CD-type such as CD-R, CD-RW and CD-ROM. However, the optical disc 100a is not limited to the above.

The optical pickup 100 optically reads the data recorded on the optical disc 100a and converts the read data to an electric signal. For this, the optical pickup 100 comprises a laser diode of two wavelengths 110, a diffraction grating 120, a beam splitter 130, a condenser lens 140, an object lens 150 and an optical detector 160.

The two-wavelength laser diode (LD) 110 comprises a light source 112 for the DVD (hereinbelow, referred to as ‘DVD light source 112’) and a light source 114 for the CD (hereinbelow, referred to as ‘CD light source 114’), for scanning lights of different wavelengths, in one casing such as a canister. In FIG. 1, a path of a light scanned from the DVD light source 112 is illustrated by a chain line, a path of a light scanned from the CD light source 114 is illustrated by a chain double-dashed line, and paths of central beams of the respective lights are illustrated by a dotted line. The DVD light source 112 and the CD light source 114 for recording and reading a certain signal with respect to the optical disc 100a are spaced from each other by a predetermined distance d.

After mounting a certain optical disc 100a in the optical reproducing apparatus 100 and determining a type of the optical disc 100a, the two-wavelength LD 110 scans a light corresponding to the type of the optical disc 100a. For example, if a DVD-type disc is mounted in the optical reproducing apparatus 100, the DVD light source 112 projects a visible ray of approximately 650 nm wavelength. If a CD-type disc is mounted, the CD light source 114 projects an infrared ray of approximately 780 nm wavelength. The two-wavelength LD 110 scans a predetermined light according to a control of the control part 300 which will be described hereinbelow.

The diffraction grating 120, being used as a beam splitter, splits the laser beam having a certain wavelength, scanned from the two-wavelength LD 110 into at least three beams (3-beam). For example, the laser beam having a certain wavelength, that passed through the diffraction grating 120, is split into a 0^{th}-beam moving straight forward and ±1^{st}-beams progressing by a certain diffraction angle. Here, the 0^{th}-beam is the central beam, and the ±1^{st}-beams are first and second peripheral lights, respectively, among the split light. A hologram element may replace the diffraction grating 120.

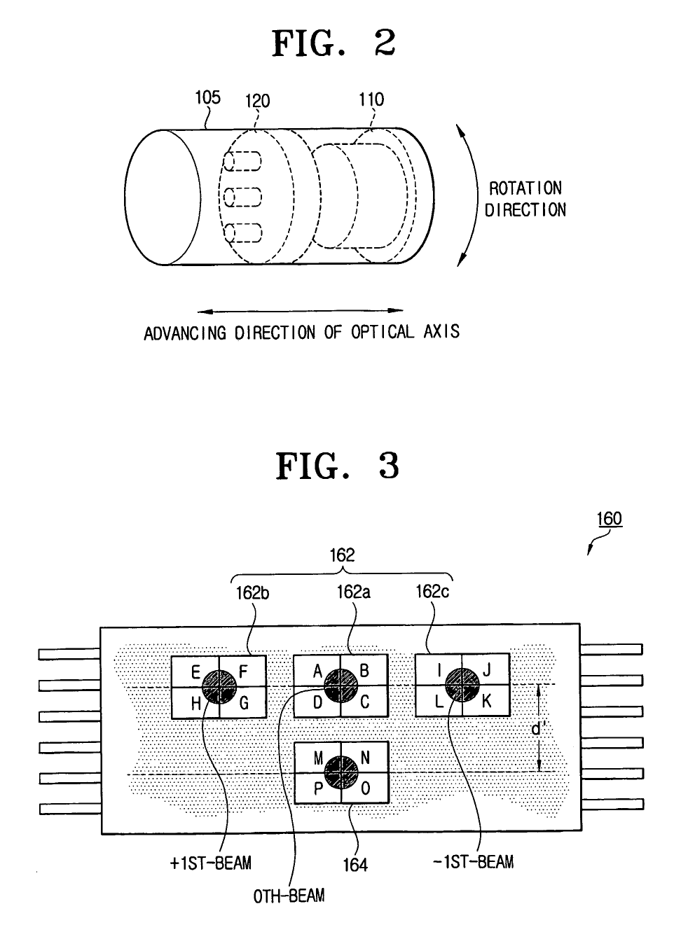

According to an embodiment of the present invention, the two-wavelength LD 110 and the diffraction grating 120 are bonded on certain positions in the holder 105, as shown in FIG. 2. In manufacturing the optical pickup 100, the two-wavelength LD 110 and the diffraction grating 120 are assembled by bonding, and the holder 105 adjusts a position for the optical pickup 100 in a base. A position of the holder 105 is determined in consideration of a position for the 3-beam split by the diffraction grating 120 to be focused, and a phase of the split 3-beam.

More specifically, the holder 105 is disposed on a first position where the 3-beam split by the diffraction grating 120 is focused on a surface of the optical disc 100a depending on the type of the optical disc 100a. The first position is determined by adjusting an optical axis offset as moving the holder 105 in an advancing direction of the optical axis.

Also, the holder 105 is disposed on a second position where the split 3-beam is incident to the optical detector 160 by a predetermined phasic difference, depending on the type of the optical disc 100a. For example, if the optical disc 100a is the DVD-type, the holder 105 is disposed such that the 0^{th}-beam and the ±1^{st}-beams, that are split by the diffraction grating 120, are incident respectively to a first central sensor 162a, and first and second peripheral sensors 162b and 162c, which will be described hereinbelow. On the contrary, if the optical disc 100a is the CD-type, the holder 105 is disposed on the second position, such that the 0^{th}-beam is incident to a CD sensor 164.

This is because a phase adjustment of a certain optical spot formed in the DVD-type and the CD-type optical discs is difficult due to a difference in a track pitch of the DVD-type and the CD-type, and therefore, the FE signal and the TE signal are generated in consideration of only the 0^{th}-beam when the CD-type optical disc 100a is in use. In other words, the FE signal and the TE signal can be detected by applying a proper method according to the track pitch of the optical disc 100a. The second position is determined by adjusting a phase of the split light as rotating the holder 105 by a predetermined angle with respect to the advancing direction of the optical axis. Especially, the track pitch of the DVD-RAM among the DVD-type is approximately 1.48 μm, and the track pitch of the other DVD-type is approximately 0.74 μm. The track pitch of the CD-type is approximately 1.6 μm.

Referring back to the FIG. 1, the beam splitter 130 makes the 3-beam split by the diffraction grating 120 to be scanned onto the optical disc 100a, and makes the 3-beam reflected from the optical disc 100a to be incident to the optical detector 160 that will be described hereinbelow.

The condenser lens 140, which is a kind of collimator lenses, converts the laser beam diffracted by a predetermined angle by the beam splitter 130 to a parallel light and outputs the parallel light.

The object lens 150 focuses the laser beam output from the condenser lens 140 onto the optical disc 100a. Also, the object lens 150 performs a focusing servo and a tracking servo by use of an actuator (not shown).

The laser beam reflected from the surface of the optical disc 100a passes through the object lens 150, the condenser lens 140 and the beam splitter 130 again, and is incident to a predetermined position of the optical detector 160. The optical detector 160 functions as a photo diode integrated circuit (IC) that detects the light reflected from the optical disc 100a and converts it to an electric signal.

According to an embodiment of the present invention, the optical detector 160 is configured as the following.

Referring to FIG. 3, the optical detector 160 is a 16-split detector which comprises a DVD sensor 162 adopted as a first detector and a CD sensor 164 adopted as a second detector. Centers of the DVD sensor 162 and the CD sensor 164 are respectively separated by a predetermined distance d′. The distance d′ is calculated in consideration of the distance d between the DVD light source 112 and the CD light source 114, characteristics of the optical element such as thickness, position and angle of the beam splitter 130, the track pitch of the optical disc 100a and the phase of the 3-beam. For instance, the distance d′ may be proportional to the thickness of the beam splitter 130.

The DVD sensor 162 receives and detects the laser beam reflected from the DVD-type optical disc 100a. More specifically, when the optical disc 100a is the DVD-RAM, the DVD sensor 162 detects a first FE signal according to the differential astigmatism detection (DAD) method and a first TE signal according to the differential push-pull (DPP) method.

If the optical disc 100a is one of the DVD±R, the DVD±RW and the DVD-ROM, the DVD sensor 162 detects a second FE signal according to astigmatism detection method and a second TE signal according to differential phase detection (DPD) method.

To this end, the DVD sensor 162 comprises the first central sensor 162a divided into four areas A, B, C and D, the first peripheral sensor 162b divided into four areas E, F, G and H, and the second peripheral sensor 162c divided into four areas I, J, K and L. The 0^{th}-beam among the three beams split by the diffraction grating 120 is incident to the first central sensor 162a, the +1^{st}-beam to the first peripheral sensor 162b, and the −1^{st}-beam to the second peripheral sensor 162c.

Meanwhile, the CD sensor 164 receives and detects the laser beam reflected from the CD-type optical disc 100a to generate a third FE signal and a third TE signal. To be more specific, when the CD-type optical disc 100a is in use, the CD sensor 164 detects the third FE signal according to the astigmatism detection method and the third TE signal according to the DPD method. For this, the CD sensor 164 is divided into four areas M, N, O and P. Only the 0^{th}-beam among the three beams split by the diffraction grating 120 is incident to the CD sensor 164.

As described above, the sensor of the optical detector 160, to which the 3-beam is incident, is different according to the type of the optical disc 100a, and this is determined by adjusting the position of the holder 105.

Hereinbelow, a signal detected from the respective areas will be denoted by the same symbol as the areas where the signal is detected, for convenient explanation.

The signals A to L detected by the DVD sensor 162 are used to generate the first FE and the first TE signals, or the second FE and the second TE signals. The signals detected by the CD sensor 164 are used to generate the third FE and the TE signal.

The signal generation part 200 generates the FE signal and the TE signal from the electric signals that are converted by the optical detector 160, by different methods preset according to the type of the optical disc 100a because a recording format, depth of a pit and the track pitch are different according to the type of the optical disc 100a. For example, according to the recording format of the DVD-RAM, the data is recorded both on land and groove areas of the optical disc 100a while the data is recorded only on the land area according to the recording format of the DVD±R, a DVD±RW and a DVD-ROM.

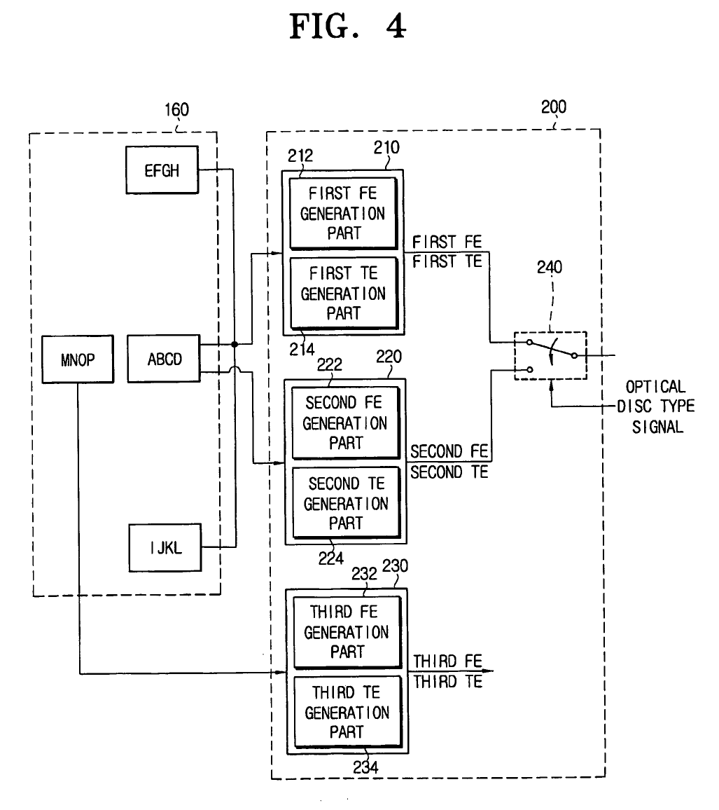

FIG. 4 is a block diagram schematically showing the signal generation part 200 connected to the optical detector of FIG. 1.

Referring to FIG. 4, the signal generation part 200 comprises a first generation part 210, a second generation part 220, a third generation part 230 and a switch part 240.

The first generation part 210 comprises a first FE generation part 212 for calculating the first FE signal by applying the DAD method with respect to the electric signal as converted by the DVD sensor 162, and a first TE generation part 214 for calculating the first TE signal by applying the DPP method. Here, when the optical disc 100a is the DVD-RAM, the depth of the pit and the track pitch are greater than those of the other types of the DVD (DVD±R, a DVD±RW and a DVD-ROM). Therefore, crosstalk occurs more when generating the first FE signal. To prevent this, the first FE signal is generated by the DAD method, such that the crosstalk can be removed by reversing the phases of the 0^{th}-beam and the ±1^{st}-beams reflected from the optical disc 100a by 180° and adding the reversed 0^{th}-beam and the ±1^{st}-beams to each other.

The second generation part 220 comprises a second FE generation part 222 for calculating the second FE signal by applying the astigmatism detection method with respect to the electric signal as converted by the DVD sensor 164, and a second TE generation part 224 for calculating the second TE signal by applying the DPD method. If the optical disc 100a is one of the DVD±R, a DVD±RW and a DVD-ROM, the laser beam reflected from the optical disc 100a has a predetermined astigmatic detection. Therefore, the second FE signal is generated by the astigmatic detection.

The third generation part 230 comprises a third FE generation part 232 for calculating the third FE signal by applying the astigmatism detection method with respect to the electric signal as converted by the CD sensor 162, and a third TE generation part 234 for calculating the third TE signal by applying the DPD method. The reason that the DPD method is applied in generating the TE signal, when the CD-type optical disc 100a is in use, is as follows. The diffraction angle by the diffraction grating 120 varies according to the wavelength of the respective laser beams, and the track pitches of the DVD and the CD respectively differ, that is, the track pitch of the DVD is 0.74 μm while that of the CD is 1.6 μm. Therefore, it is difficult to adjust the phase of the laser beam, which corresponds to the different diffraction angles, using the 3-beam method. In other words, in order to overcome the difficulty caused due to the phase difference of the laser beams according whether the optical disc 100a is the DVD or the CD, the DPD method is used in generating the TE signal.

The switch part 240, being controlled by the control part 300, switches one of the first generation part 210 and the second generation part 220.

The control part 300 controls the switch part 240 according to the type of the optical disc 100a. For instance, if the DVD-RAM is used as the optical disc 100a, the control part 300 controls the switch part 240 to switch the first generation part 210, so that the first FE and the first TE signals are output. If one of the DVD±R, the DVD±RW and the DVD-ROM is used as the optical disc 100a, the control part 300 controls the switch part 240 to switch the second generation part 220, so that the second FE and the second TE signals are output.

Hereinbelow, a method for generating the FE signal and the TE signal will be described in greater detail with reference to a connection between the optical detector 160 and the signal generation part 200.

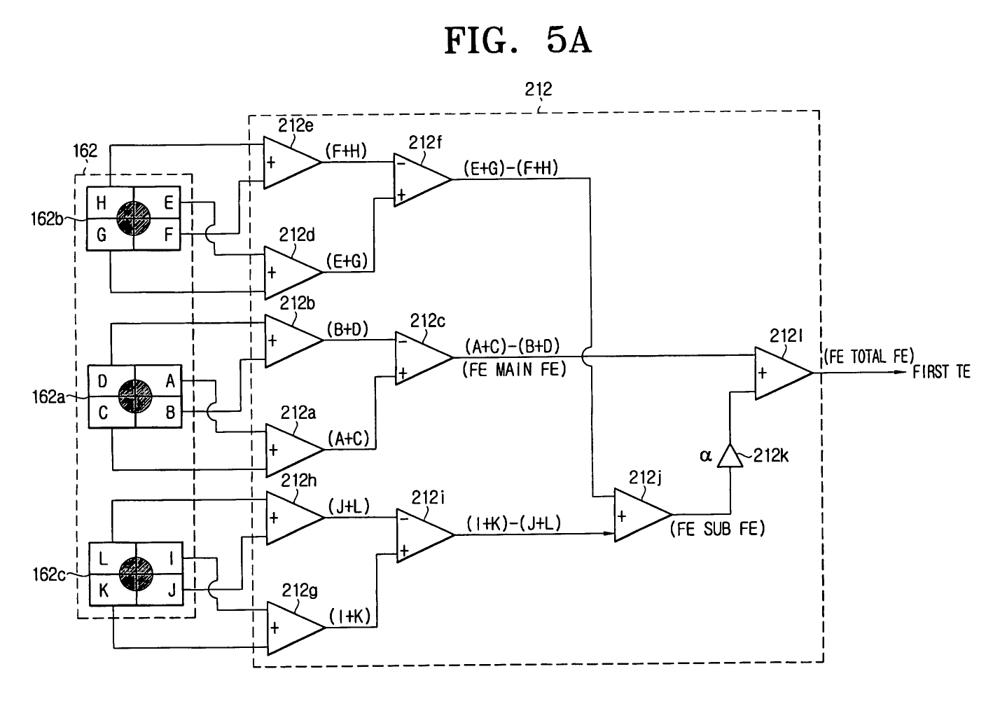

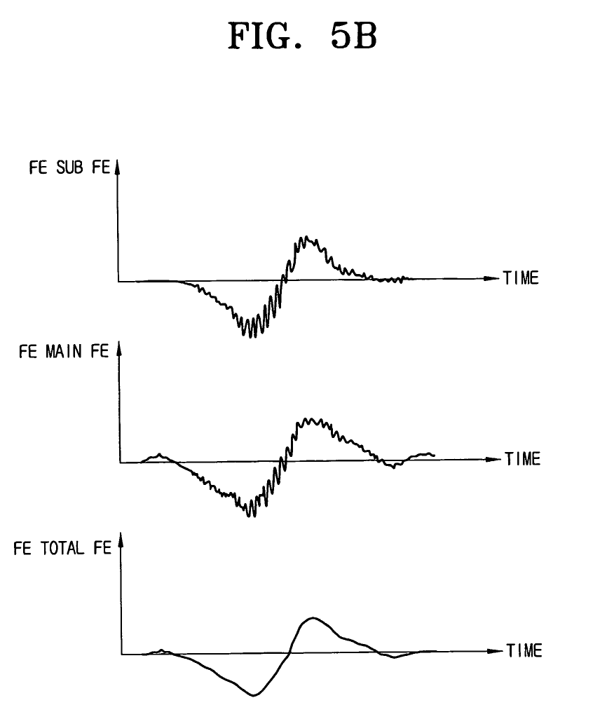

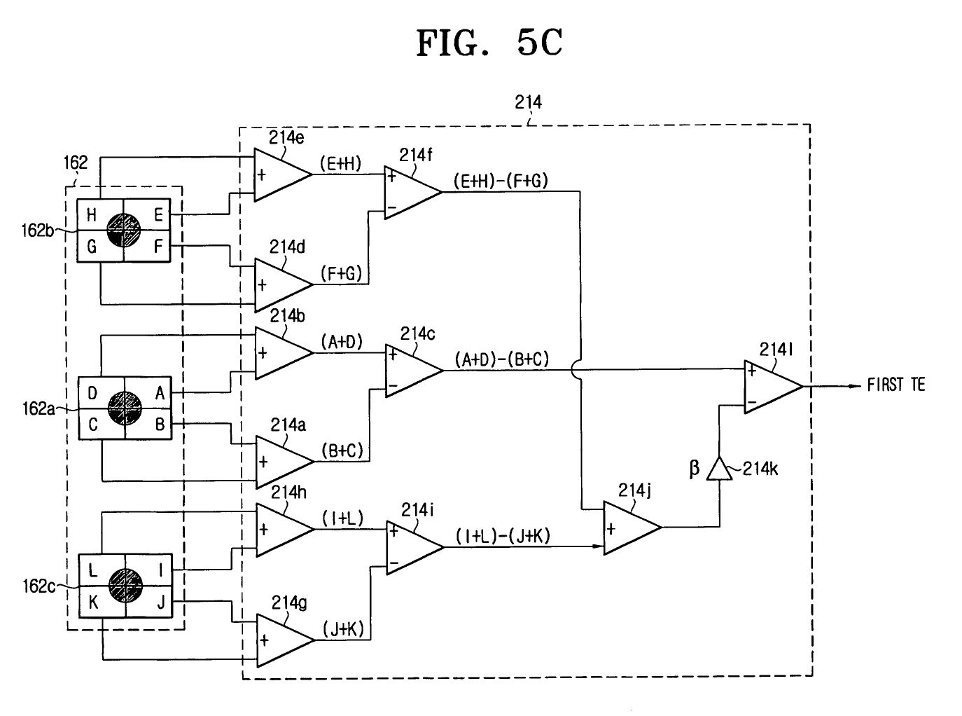

FIG. 5A is a circuit diagram illustrating the DVD sensor and the first FE generation part for explaining a method for generating the first FE signal from the DVD-RAM.

Referring to FIG. 5A, the first FE generation part 212 generates the first FE signal based on the DAD method. When the DVD-RAM is used as the optical disc 100a, the generated first FE signal is used for the focusing servo of the optical pickup 100.

Therefore, the first FE generation part 212 comprises first and second adders 212a and 212b, a first subtractor 212c, third and fourth adders 212d and 212e, a second subtractor 212f, fifth and sixth adders 212g and 212h, a third subtractor 212i, a seventh adder 212j, an amplifier 212k and an eighth subtractor 212l.

The first adder 212a adds signals A and C, and the second adder 212b adds signals B and D, among the signals A to D of the 0^{th}-beam. The first subtractor 212c calculates (A+C)−(B+D), thereby generating a main FE ((A+C)−(B+D)) signal.

The third adder 212d adds signal E and G, and the fourth adder 212e adds signals F and H, among the signals of the +1^{st}-beam. The second subtractor 212f calculates (E+G)−(F+H).

The fifth adder 212g adds signal I and K, and the sixth adder 212h adds signals J and L, among the signals of the −1^{st}-beam. The third subtractor 212i calculates (I+K)−(J+L).

The seventh adder 212j adds {(E+G)−(F+H)} to {(I+K)−(J+L)}.

The amplifier 212k amplifies the signal output from the seventh adder 212j by a predetermined multiple ‘α’ to generate a sub FE signal (α{(E+G)−(F+H)+(I+K)−(J+L)}). The multiple ‘α’ is a gain applied to the sub FE signal to detect an optimum first FE signal by the DPA. The ‘α’, a gain corresponding to an intensity of radiation of the 0^{th}-beam and the ±1^{st}-beams, is set in the form of a certain lookup table (not shown).

The eighth adder 212l adds the main FE signal and the sub FE signal, thereby generating a total FE signal, that is, the first FE signal. Thus, the first FE signal of the DVD-RAM is generated by the DAD method. More specifically, the first FE generation part 212 reverses the phases of the 0^{th}-beam and the +1^{st}-beams by 180° by applying the DAD method, thereby removing remaining crosstalk by addition of the main FE signal and the sub FE signal which are detected from the 0^{th}-beam and the ±1^{st}-beams. In other words, since the phase difference between the 0^{th}-beam and the ±1^{st}-beams incident to the DVD sensor 162 is 180°, the remaining crosstalk of the main and the sub FE signals generated from the first FE calculation part 212 is removed as shown in FIG. 5B.

FIG. 5C is a circuit diagram illustrating the DVD sensor and the first TE generation part for explaining a method for detecting the first TE signal from the DVD-RAM.

Referring to FIG. 5C, the first TE generation part 214 generates the first TE signal according to the DPD method. The generated first TE signal is used for the tracking servo of the optical pickup 100 when the optical disc 100a is the DVD-RAM.

For this, the first TE generation part 214 comprises first and second adders 214a and 214b, a first subtractor 214c, third and fourth adders 214d and 214e, a second subtractor 214f, fifth and sixth adders 214g and 214h, a third subtractor 214i, a seventh adder 214j, an amplifier 214k and a fourth subtractor 214l.

The first adder 214a adds signals B and C, and the second adder 214b adds signals A and D, among the signals of the 0^{th}-beam. The first subtractor 214c calculates (A+D)−(B+C).

The third adder 214d adds signal F and G, and the fourth adder 214e adds signals E and H, among the signals of the +1^{st}-beam. The second subtractor 214f calculates (E+H)−(F+G).

The fifth adder 214g adds signal J and K, and the sixth adder 214h adds signals I and L, among the signals of the −1^{st}-beam. The third subtractor 214i calculates (I+L)−(J+K).

The seventh adder 214j adds {(E+H)−(F+G)} to {(I+L)−(J+K)} since {(E+G)−(F+H)} and {(I+K)−(J+L)} have the same phase difference.

The amplifier 214k amplifies the signal output from the seventh adder 214j by a predetermined multiple ‘β’, thereby generating β[{(E+H)−(F+G)+(I+L)−(J+K)}]. The multiple ‘β’ is a gain applied to detect an optimum first TE signal by the DPD method.

The fourth subtractor 214l subtracts a signal output from the amplifier 214k from a signal output from the first subtractor 214c, thereby generating ‘{(A+D)−(B+C)}−β[{(E+H)−(F+G)}+{(I+L)−(J+K)}], that is, the first TE signal. Thus, the first TE signal of the DVD-RAM is generated by the DPD method, and accordingly, a DC offset caused as the object lens 150 moves can be minimized.

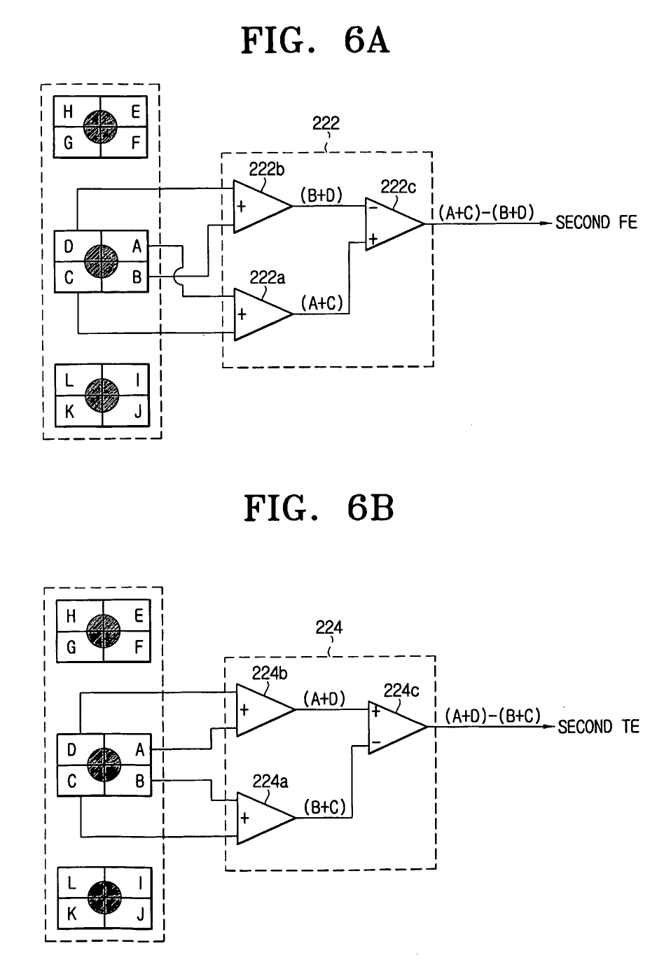

FIG. 6A is a circuit diagram illustrating the DVD sensor and the second FE generation part for explaining a method for detecting the second FE signal when the optical disc 100a of FIG. 1 is one of the DVD±R, a DVD±RW and a DVD-ROM.

Referring to FIG. 6A, the second FE generation part 222 generates the second FE signal by the astigmatism detection method. The generated second FE signal is used for the focusing servo of the optical pickup 100. Therefore, the second FE generation part 222 comprises first and second adders 222a and 222b and a first subtractor 222c.

The first adder 222a adds signals A and C among the signals of the 0^{th}-beam. The second adder 222b adds signals B and D. The first subtractor 222c calculates (A+C)−(B+D), thereby generating the second FE signal ((A+C)−(B+D)).

FIG. 6B is a circuit diagram of the DVD sensor and the second TE generation part for explaining a method for detecting the second TE signal when the optical disc 100a of FIG. 1 is one of the DVD±R, a DVD±RW and a DVD-ROM.

Referring to FIG. 6B, the second TE generation part 224 generates the second TE signal based on the DPD method. The generated second TE signal is used for the tracking servo of the optical pickup 100. For this, the second TE generation part 224 comprises first and second adders 224a and 224b, and a first subtractor 224c.

The first adder 224a adds signals B and C, and the second adder 224b adds signals A and D, among the signals of the 0^{th}-beam. The first subtractor 224c calculates (A+D)−(B+C), thereby generating the second TE ((A+D)−(B+C)) signal.

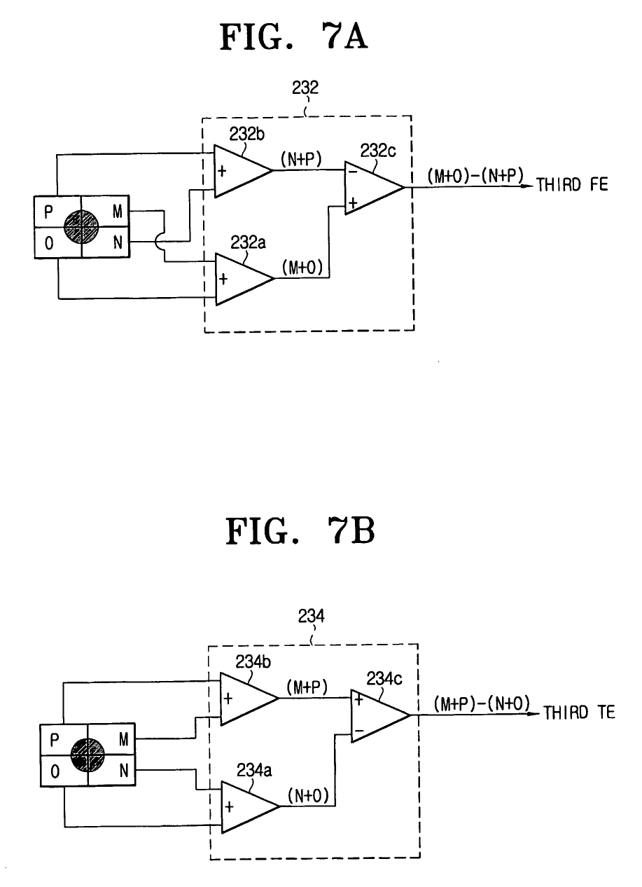

FIG. 7A is a circuit diagram of the CD sensor and the third TE generation part for explaining a method for detecting the third FE and the third TE signals when the optical disc 100a of FIG. 1 is the CD.

Referring to FIG. 7A, the third generation part 232 generates the third FE signal according to the astigmatism detection method. The generated third FE signal is used for the focusing servo of the optical pickup 100. For this, the third FE generation part 332 comprises first and second adders 232a and 232b, and a first subtractor 232c.

The first adder adds signals M and O, and the second adder 232b adds signals N and P, among the signals of the 0^{th}-beam detected by the CD sensor 164. The first subtractor 232c calculates (M+O)−(N+P), thereby generating the third FE ((M+O)−(N+P)) signal.

FIG. 7B is a circuit diagram of the CD sensor and the third TE generation part for explaining a method for detecting the third TE signal when the optical disc 100a of FIG. 1 is the CD.

Referring to FIG. 7B, the third TE generation part 232 generates the third TE signal according to the DPD method. The generated third TE signal is used for the tracking servo of the optical pickup 100. Therefore, the third TE generation part 234 comprises first and second adders 234a and 234b, and a first subtractor 234c.

The first adder 234a adds signals N and O, and the second adder 234b adds signals M and P, among the signals of the 0^{th}-beam detected by the CD sensor 164. The first subtractor 234c calculates (M+P)−(N+O), thereby generating the third TE ((M+P)−(N+O)) signal.

The methods for generating the FE and TE signals according to the type of the optical disc 100a can be expressed by [Table 1] as the following.

TABLE 1

| Type of | FE signal | | TE signal | |
|---|---|---|---|---|
| optical disc | method | signal | method | Signal |
| DVD-RAM | DAD | {(A + C) − | DPP | {(A + D) − |
| | method | (B + D)} + | method | (B + C)} − |
| | | α[{(E + G) − | | β[{(E + H) − |
| | | (F + H)} + | | (F + G)} + |
| | | {(I + K) − | | {(I + L) − |
| | | (J + L)}] | | (J + K)}] |
| DVD±R/±RW/ | Astigmatism | (A + C) − | DPD | (A + D) − |
| ROM | detection | (B + D) | method | (B + C) |
| | method | | | |
| CD | Astigmatism | (M + O) − | DPD | (M + P) − |
| | detection | (N + P) | method | (N + O) |
| | method | | | |

Referring to [Table 1], when the two-wavelength LD 110 is in use, the FE and the TE signals are calculated by the methods set according to the type of the optical disc 100a when the data recorded on the optical disc 100a is reproduced. Additionally, when the optical disc 100a is the DVD-type, the RF signal (A+B+C+D) is generated, and when the optical disc 100 is the CD-type, the RF signal (M+M+O+P) is generated.

Meanwhile, the third TE signal calculated by the third calculation part 168 is also obtainable by the 3-beam method as well as the DPD method. The 3-beam method is used by adjusting the diffraction angle such that the 3-beam is formed on the least commonmultiple track of the track pitches of the DVD and the CD. This is because the track pitches of the DVD and the CD are different.

Hereinbelow, according to the type of the optical disc 100a, the methods for generating the FE and the TE signals will now be described in consideration of the relationship between the optical detector 160 and the signal generation part 200 of FIG. 1.

Also, by applying the optical detector 160 according to an embodiment of the present invention to the optical pickup 100 that emits the two-wavelength laser beam, the FE and the TE signals appropriate for the type of the optical disc 100a can be detected using the simple optical system, as shown in FIG. 1.

As described above, by use of the optical reproducing apparatus according to an embodiment of the present invention, the focusing error signal is generated by one of the DAD method and the astigmatism detection method while the tracking error signal is generated by one of the DPP method and the DPD method. Accordingly, the tracking servo and the focusing servo can be implemented regardless of the track pitch or depth of the pit of the optical disc. Especially, when using the CD, a process of adjusting the phase can be omitted by applying the DPD method. Further, since equipment for verifying the phase becomes unnecessary, productivity improves and the manufacturing cost can be minimized.

While the invention has been shown and described with reference to certain embodiments thereof, it will be understood by those skilled in the art that various changes in form and details may be made therein without departing from the spirit and scope of the invention as defined by the appended claims.

### INDUSTRIAL APPLICABILITY

The present invention is applicable to an optical reproducing apparatus that detects a laser beam scanned from a two-wavelength laser diode, converts the laser beam into an electrical signal, and generates a focusing error signal and a tracking error signal using a method preset according to a type of optical discs.

1. An optical reproducing apparatus having an optical pickup for reading data recorded on an optical disc and converting the data into electric signals and a signal generation part for generating a tracking error signal and a focusing error signal from the electric signals, the optical pickup comprising:
a two-wavelength light source projecting a predetermined light having a wavelength according to a type of the optical disc;
a beam splitter splitting the projected predetermined light into at least three beams and scanning the split light onto the optical disc; and
an optical detector, divided into a plurality of detecting areas, and converting at least one of the three beams reflected from the optical disc into the electric signals, detecting the focusing error signal from the electric signals using a differential astigmatism detection method or an astigmatism detection method, and detecting the tracking error signal from the electric signals using differential push-pull detection or differential phase detection, according to the type of the optical disc.

2. The optical reproducing apparatus of claim 1, wherein the optical detector comprises:
a first detector having twelve subdivided areas to detect the at least three lights reflected from the optical disc and convert the detected lights to the electric signals; and
a second detector having four subdivided areas to detect a central light among the at least three lights reflected from the optical disc and convert the central light to the electric signals.

3. The optical reproducing apparatus of claim 2, wherein the first detector comprises:
a first central sensor having four subdivided areas including first, second third and fourth areas to detect the central light among the at least three lights reflected from the optical disc, and convert the detected central light to a first group of the electric signals;
a first peripheral sensor having fifth, sixth, seventh and eighth areas to detect a first peripheral light among the at least three lights reflected from the optical disc, and convert the detected first peripheral light to a second group of the electric signals; and
a second peripheral sensor having ninth, tenth, eleventh and twelfth areas to detect a second peripheral light among the at least three lights reflected from the optical disc, and convert the detected second peripheral light to a third group of the electric signals.

4. The optical reproducing apparatus of claim 2, wherein the at least three lights are incident to one of the first and the second optical detectors according to the type of the optical disc.

5. The optical reproducing apparatus of claim 4, wherein the signal generation part comprises:
a first generation part generating a first focusing error signal by applying the differential astigmatism detection method and a first tracking error signal by applying the differential push-pull to some of the electric signals converted by the first detector;
a second generation part generating a second focusing error signal by applying the astigmatism detection method and a second tracking error signal by applying the differential phase detection to some of the electric signals converted by the first detector; and
a third generation part generating a third focusing error signal by applying the astigmatism detection method and a third tracking signal by applying the differential phase detection to some of the electric signals converted by the second detector.

6. The optical reproducing apparatus of claim 5, wherein:
where the optical disc is one of the DVD-R, the DVD+R, the DVD-RW, the DVD+RW, the DVD-ROM, and the DVD-RAM, at least one of the three lights is incident to the first detector, and
where the optical disc is the CD, the central light among the at least three lights is incident to the second detector.

7. The optical reproducing apparatus of claim 6, wherein:
the signal generation part further comprises a switch part switching one of the first and the second generation parts according to the type of the optical disc, and
where the optical disc is the DVD-RAM, the switch part switches the first generation part to selectively output the first focusing and the first tracking error signals.

8. The optical reproducing apparatus of claim 6, wherein:
the signal generation part further comprises a switch part switching one of the first and the second generation parts according to the type of the optical disc, and
where the optical disc is one of the DVD-R, the DVD+R, the DVD-RW, the DVD+RW, and the DVD-ROM, the switch part switches the second generation part to selectively output the second focusing and the second tracking error signals.

9. The optical reproducing apparatus of claim 1, wherein:
the optical pickup further comprises a holder fixing the two-wavelength light source and the beam splitter, and
the holder is disposed at a position where the at least three lights are incident to a surface of the optical disc and a position where the at least three lights are incident to the optical detector by a predetermined phasic difference.

10. An optical pickup comprising:
a light source selectively projecting a light having a wavelength determined according to a type of an optical disc having data to be read by the optical pickup;
an optical system splitting the projected light into three beams, scanning the three beams onto the optical disc and gathering reflected light corresponding to the three beams;
an optical detector, divided into first, second, third and fourth detecting areas, the first second and third detection areas detecting the three beams from the gathered light where the projected light has a first wavelength and the fourth detection area detecting one of the three beams from the gathered light where the projected light has a second wavelength;
a signal generator:
generating a first tracking error signal and a first focus error signal or a second tracking error signal and a second focus error signal in response to the light detected by the first, second and third detection areas where the projected and reflected lights have the first wavelength and the type of the optical disc is a first type of optical disc, and
generating a third tracking error signal and a third focus error signal in response to the light detected by the fourth detection area where the projected and reflected lights have the second wavelength and the type of the optical disc is a second type of optical disc; and
a switch selectively outputting the first tracking error signal and the first focus error signal or the second tracking error signal and the second tracking error signal where the of the optical disc is the DVD.

11. The optical pickup of claim 10, wherein:
the light source comprises:
a holder,
first and second laser diodes mounted in the holder and spaced apart by a first predetermined distance, wherein one of the first and second diodes is selectively activated to provide the projected light; and
the first, second and third detection areas are arranged inline and offset from the fourth detection area by a second predetermined distance calculated in consideration of the first predetermined distance and characteristics of the optical system.

12. The optical pickup of claim 10, wherein the three beams correspond respectively to 0th order, +1st order and −1st order beams.

13. The optical pickup of claim 12, wherein:
where the type of the optical disc is a DVD, the first, second and third detection areas detect the 0th order, +1st order and −1st order beams, respectively.

14. The optical pickup of claim 13, wherein:
where the type of the optical disc is a CD, the fourth detection area detects one of the 0th order, +1st order and −1st order beams.

15. The optical pickup of claim 13, wherein:
the first, second and third detection areas are subdivided and the subdivided areas are arranged in first, second and third arrays, respectively, each having 2 rows and 2 columns, each subdivision generating a corresponding signal in response to a portion of the gathered light, and
the first focus error signal is determined by sums and differences of the signals corresponding to diagonal corners of the arrays.

16. The optical pickup of claim 13, wherein:
the first, second and third detection areas are subdivided and the subdivided areas are arranged in first, second and third arrays, respectively, each having 2 rows and 2 columns, each subdivision generating a corresponding signal in response to a portion of the gathered light, and
the first tracking error signal is determined by sums and differences of the signals corresponding to adjacent corners of the arrays.

17. The optical pickup of claim 13, wherein:
the second detection area is subdivided and the subdivided areas are arranged in an array having 2 rows and 2 columns, each subdivision generating a corresponding signal in response to a portion of the gathered light, and
the second focus error signal is determined by a difference of sums of the signals corresponding to diagonal corners of the array.

18. The optical pickup of claim 13, wherein:
the second detection area is subdivided and the subdivided areas are arranged in an array having 2 rows and 2 columns, each subdivision generating a corresponding signal in response to a portion of the gathered light, and
the second tracking error signal is determined by a difference of sums of the signals corresponding to adjacent corners of the array.

19. The optical pickup of claim 14, wherein:
the fourth detection area is subdivided and the subdivided areas are arranged in an array having 2 rows and 2 columns, each subdivision generating a corresponding signal in response to a portion of the gathered light, and
the third focus error signal is determined by a difference of sums of the signals corresponding to diagonal corners of the array.

20. The optical pickup of claim 14, wherein:
the fourth detection area is subdivided and the subdivided areas are arranged in an array having 2 rows and 2 columns, each subdivision generating a corresponding signal in response to a portion of the gathered light, and
the third tracking error signal is determined by a difference of sums of the signals corresponding to adjacent corners of the array.
